(19) United States
(12) Patent Application Publication
(10) Pub. No.: US 2019/0285940 A1
(43) Pub. Date: Sep. 19, 2019

(54) DISPLAY DEVICE

(71) Applicant: SHARP KABUSHIKI KAISHA, Sakai City (JP)

(72) Inventor: KOSHU YONEMURA, Sakai City (JP)

(21) Appl. No.: 16/295,309

(22) Filed: Mar. 7, 2019

(30) Foreign Application Priority Data
Mar. 16, 2018 (JP) 2018-049334

(51) Int. Cl. G02F 1/1335; G02F 1/1333; G09G 3/20

(52) U.S. Cl. CPC G02F 1/133602; G02F 1/133308; G02F 2001/13332; G02F 2001/133314; G09G 3/2022

(57) ABSTRACT

A display device includes a display panel, a lighting device, an adherence component connecting the display panel and the lighting device, and a protective panel on the display panel while overlapping the display panel. The protective panel has a part of a peripheral end as a protruding part protruding outside an outer end of the display panel. The lighting device has a part of a peripheral end as a protruding overlapped part overlapping the protruding part. The protruding part includes a first engaging part and the protruding overlapped part includes a second engaging part. The first engaging part is spaced from the second engaging with a space therebetween is a normal line direction of the display surface and a normal orthogonal direction orthogonal to the normal line direction and the second engaging part is configured to be fit to the first engaging part at least in the normal line direction.

### CROSS REFERENCE TO RELATED APPLICATION

This application claims priority from Japanese Patent Application No. 2018-049334 filed on Mar. 16, 2018. The entire contents of the priority application are incorporated herein by reference.

### TECHNICAL FIELD

The technology described herein relates to a display device.

### BACKGROUND

In the past, an example of a liquid crystal display device includes a display panel, a cover glass provided in the display surface side of the display panel, a back side member made from synthetic resin or metal and provided in the back side of the display panel, and a connecting member made from metal and having first plate-shaped part and a second plate-shaped part with a bent part sandwiched therebetween, wherein the display panel is adhered to the back side member, and the first plate-shaped part is adhered to the cover glass, and the second plate-shaped part is connected to the back side member.

### SUMMARY

In the above technology, the connecting member absorbs an expansion/contraction amount difference associated with thermal expansion/contraction caused by a linear expansion coefficient difference between the cover glass and the back side member. The expansion/contraction associated with the thermal expansion/contraction is not one which is generated suddenly, but is a phenomenon which is generated while a certain time is taken. On the other hand, a displacement resulting from vibration and shock, etc. may be unable to be dealt with appropriately with the above configurationl because the displacement is a phenomenon which is generated suddenly. When the displacement resulting from the vibration and shock, etc. is generated in the above configuration, the displacement may be absorbed by deformation of the connecting member, but a strong resistance force may be applied, and thereby, a stress is easy to be applied on the display panel resulting from the resistance force, and there is a possibility that a display quality of the display panel may be deteriorated.

The technology described herein is completed in view of the above circumstances, and an object is to cause less application of stress on the display panel.

The display device of the technology described herein includes a display panel configured to have a display surface to display an image, a lighting device configured to be arranged so as to overlap with the display panel and to irradiate the display panel with light for displaying, an adherence component that is between the display panel and the lighting device and connects the display panel and the lighting device, a protective panel configured to be attached on the display panel on an opposite side from the lighting device while overlapping the display panel. The protective panel has a part of a peripheral end as a protruding part protruding outside an outer end of the display panel and the lighting device has a part of a peripheral end as a protruding overlapped part arranged so as to overlap with the protruding part. The protruding part includes a first engaging part and the protruding overlapped part includes a second engaging part. The first engaging part is spaced from the second engaging part while having a space therebetween with respect to a normal line direction of the display surface and a normal orthogonal direction orthogonal to the normal line direct on and the second engaging part is configured to be fit to the first engaging part at least in the normal line direction.

In this way, an image is displayed on the display surface of the display panel by using the light emitted from the lighting device. The display panel has the protection achieved by the protective panel arranged so as to overlap with the opposite side to the lighting device side. The protective panel has the protruding part where at least a part f the peripheral end protrudes outside the outer end of the display panel, and the protruding overlapped part made of at least a part of the peripheral end of the lighting device is arranged so as to overlap with the protruding part. The display panel and the lighting device which are overlapped mutually are adhered to each other with the adherence component which intervenes between them. Since adhered to the display panel, the adherence component may have restrictions in an arrangement space and a material, and in that case, it may become difficult to make fixing force high. On the other hand, since the protective panel is attached to the display panel, strong loading by the weight is applied to the adherence component in the normal line direction of the display surface when vibration and shock, etc. are applied, and there is a possibility that a peeling may arise with respect to the adherence component.

Then, since the first engaging part is provided in the protruding part of the protective panel, and the second engaging part which is engageable with the first engaging part in the normal line direction of the display surface is provided in the protruding overlapped part of the lighting device, the first engaging part and the second engaging part are engaged when an above-mentioned vibration and shock, etc. are applied, and thereby, the protective panel/display panel and the lighting device can be prevented from being displaced relatively in the normal line direction of the display surface. As a result, it becomes difficult that the peeling may arise in the adherence component. Moreover, since the second engaging part is arranged with a gap left in the normal line direction of the display surface with respect to the first engaging part, the relative displacement of the protective panel /display panel and the fighting device is allowed within a limit of the gap in the above-mentioned normal line direction. As a result, when the above-mentioned vibration and shock, etc. are applied, a stress associated with that can be avoided from being applied to the display panel without interruption, and deterioration of a displaying quality of the display panel s suppressed. Furthermore, since the second engaging part is arranged with a gap left in the normal orthogonal direction which is orthogonal to the normal line direction of the display surface with respect to the first engaging part, a protective panel/display panel and the lighting device is guaranteed to be displaced relatively smoothly in a normal line direction, and it can be avoided that the strong resistance force is applied as in the past. As a result, since the stress becomes difficult to be applied to the display panel in accordance with the relative displacement of the protective panel/display panel and the lighting device, the deterioration of the displaying quality of the display panel is preferably suppressed.

Incidentally, although in addition to vibration and shock, deformation and inclination, etc. may arise in at least one of the protective panel/display panel and the lighting device, even in such cases, a stress which arises in accordance with the deformation and inclination, etc. becomes difficult to be applied to the display panel by the first engaging part and the second engaging part having the configuration described above.

According to the technology described herein, a stress is less likely to be applied on the display panel.

### BRIEF DESCRIPTION OF THE DRAWINGS

FIG. 1 is a sectional view of a liquid crystal display device according to a first embodiment.

FIG. 2 is a plan view of the liquid crystal panel and a back light main body constituting the liquid crystal display device.

FIG. 3 is an enlarged sectional view of a first engaging part and a second engaging part in the liquid crystal display device.

FIG.4 is a sectional view of the liquid crystal display device illustrating a state where the liquid crystal panel and a cover glass are inclined.

FIG. 5 is a sectional view of the liquid crystal display device according to a second embodiment.

FIG. 6 is a sectional view of the liquid crystal display device according to a third embodiment.

### DETAILED DESCRIPTION

### First Embodiment

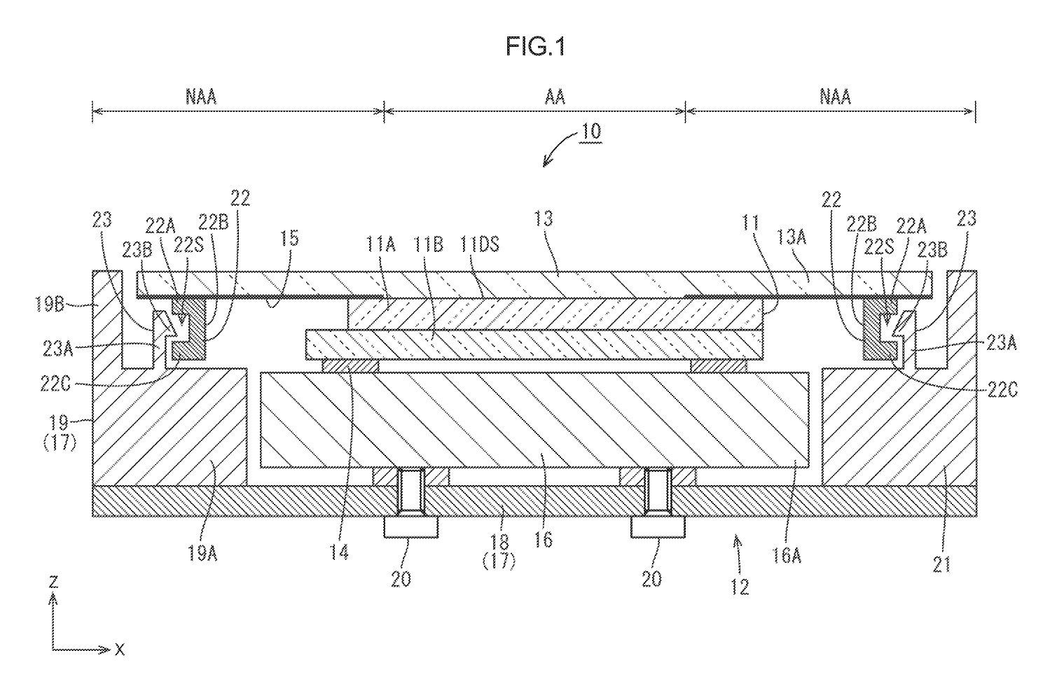

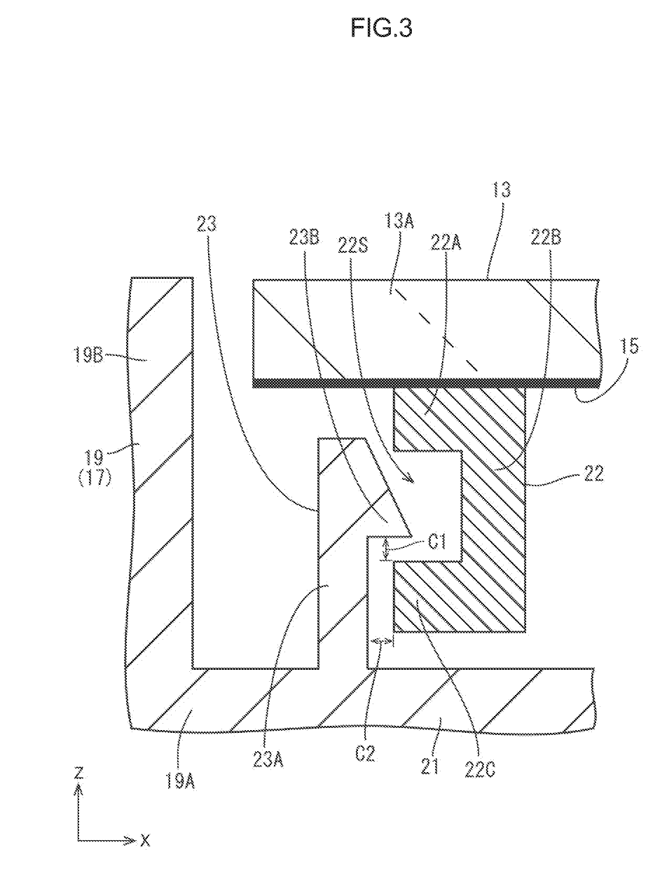

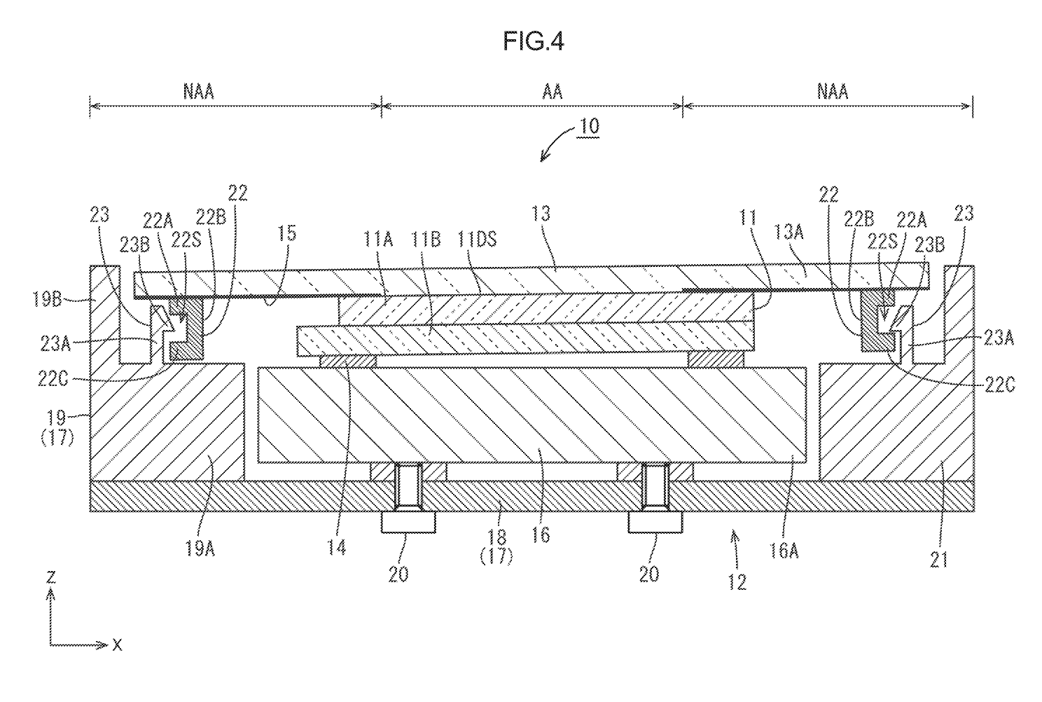

A first embodiment will be described with reference to FIGS. 1 to 4. In the present embodiment, a liquid crystal display device 10 will be illustrated. Note that in a part of each of FIGS., X-axis, Y-axis and Z-axis are illustrated, and the direction of each axis is drawn so as to be the direction illustrated in each of FIGS. In addition, the upper side of FIG. 1, FIG. 3 and FIG. 4 is made to be a front side, and the underside of the same FIGS. is made to be a back side.

The liquid crystal display device 10, as illustrated in FIG. 1, is at least provided with a liquid crystal panel (display panel) 11 having a display surface 11DS to display a picture, a back light device (lighting device) 12 which irradiates the liquid crystal panel 11 with the light for displaying and is arranged so as to overlap with the back side (the opposite side to a cover glass 13 side) with respect to the liquid crystal panel 11, a cover glass (protective panel) 13 arranged in a form of covering the liquid crystal panel 11 from the front side opposite side to the back light device 12 side), and a adherence component 14 which intervenes between the liquid crystal panel 11 and the back light device 12 and adheres these.

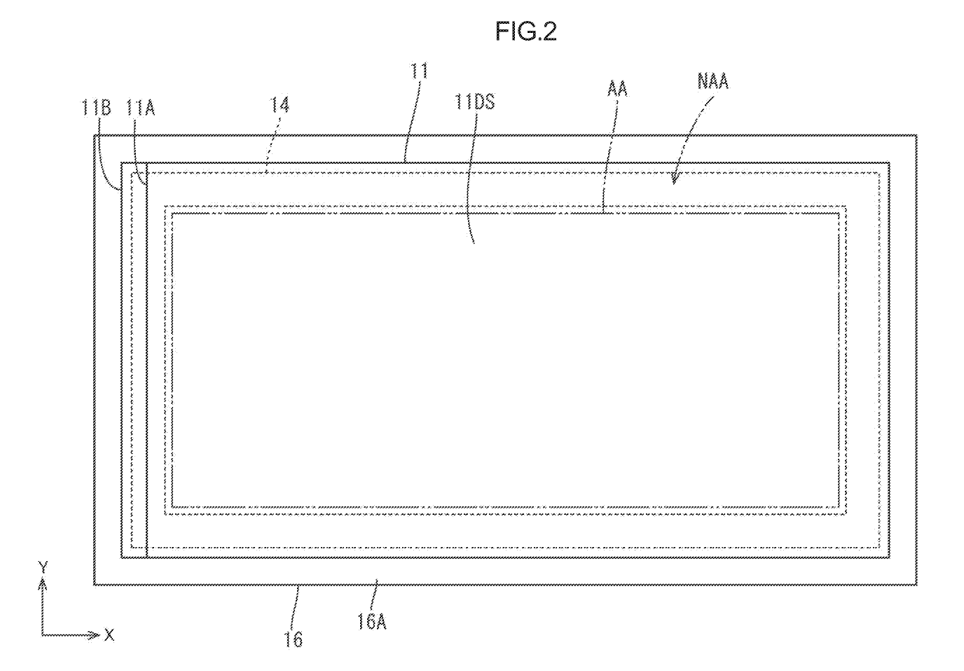

The liquid crystal panel 11, as illustrated in FIG. 1 and FIG. 2, forms an oblong rectangular shape. The long side direction is in respectively agreement with an X axial direction, and the short side direction i in agreement with a Y axial direction, and a normal line direction of a plate surface (including the display surface 11DS) is in agreement with a Z axial direction. Note that it can be said that the X axial direction and Y axial direction are “normal orthogonal directions” which are orthogonal to the normal line direction of the plate surface of the liquid crystal panel 11. The liquid crystal panel 11, while a pair of substrates 11A and 11B which are made from of glass and almost transparent are stuck together in a state where a prescribed gap (cell gap) is maintained, is assumed to have a configuration with a liquid crystal layer enclosed between both substrates 11A and 11B. The liquid crystal panel 11 according to the present embodiment is assumed to be an IPS (In-Plane Switching) mode where liquid crystal molecules constituting the liquid crystal layer are horizontally aligned. Among a pair of substrates 11A and 11B, on the array substrate (active matrix substrate) 11B arranged on the back side, provided are a swilling element (for example, TFT) connected to a source line and gate line which are orthogonal to each other, and a picture element electrode which is connected to the switching element and an orienting film, etc. On the other hand, on CF substrate (counter substrate) 11A arranged on the front side, a color filter where each coloring section such as R (red), G (green), and B (blue) is arranged in prescribed arrangement, and a shade part (black matrix) partitioning adjacent coloring sections are provided, and in addition to that, the orienting film, etc. are provided. The liquid crystal panel 11 has the display surface 11DS partitioned into a display area (active area) AA located in the center side in which a picture is displayed, and a non-display area (non-active area) NAA located in the peripheral edge side which forms a picture frame-like shape (frame shape) enclosing the display area AA and in which a picture is not displayed. Note that, in FIG. 2, a dashed dotted line indicates an external form of the display area AA, and an area outside the dashed dotted line indicates the non-display area NAA. In addition, on both the external surfaces of the front side and back side in the liquid crystal panel 11, a pair of polarizing plates are pasted.

The cover glass 13 will be described in advance. The cover glass 13, as illustrated in FIG. 1, covers the liquid crystal panel 11 over almost the whole area thereof from the front side, and thereby, it is possible to achieve protection of the liquid crystal panel 11. The cover glass 13 has a size larger external form than the liquid crystal panel 11 and a back light main body 16 mentioned below, and the peripheral end thereof is assumed to be a protruding part 13A protruding outside the peripheral end of the liquid crystal panel 11. The cover glass 13 forms a shape of a glass plate which is almost transparent and has excellent translucency, and preferably is made from a strengthened glass. As the strengthened glass used for the cover glass 13, a chemically-strengthened glass provided with a chemical-strengthening layer on a surface thereof by chemical strengthening treatment being applied to a surface of a plate-shaped glass base material is preferred to be used, for example, but it is not necessarily limited to this. On the peripheral end of the cover glass 13, provided is a frame-shaped shade part. 15 having a light blocking effect in a form of extending over the entire periphery. The frame-shaped shade part 15 is arranged in a form of overlapping with the non-display area NAA of the liquid crystal panel 11 in a plan view, and surrounds the display area AA. The frame-shaped shade part. 15 has a light-shielding film made from light blocking effect material (carbon black and metallic material, etc., for example) formed on the plate surface of the back side in the peripheral end of: the cover glass 13. Note that the frame-shaped shade part 15 is illustrated by the thick line in FIG. 1. The cover glass 13 is adhered to the liquid crystal panel 11 by the translucency adhering layer which intervenes therebetween. The translucency adhering layer is made from an adhesive-material layer such as an OCA (Optical Clear Adhesive) film, etc., for example, which is almost transparent and has excellent translucency.

The back light device 12, as illustrated in FIG. 1, has at least the back light main body (lighting device main body) 16 which emits light, and a main body fixing component 17 fixed to the back light main body 16. The back light main body 16, as illustrated in FIG. 1 and FIG. 2, forms a size larger oblong rectangular shape than the liquid crystal panel 11, and the peripheral end has protruded outside the peripheral end of the liquid crystal panel 11, and is assumed to be a main body protruding overlapped part (protruding overlapped part) 16A which overlaps in a plan view with the protruding part 13A of the cover glass 13. As for the back light main body 16, at least a portion overlapping with the display area AA in a plan view is assumed to be an effective light emitting area which emits light effectively, and on the other hand, a peripheral edge side portion enclosing an effective light emitting area is assumed to be a non-effective light emitting area. As for the back light device 12, the non-effective light emitting area overlaps each in a plan view with the non-display area NAA of the liquid crystal panel 11 and the frame-shaped shade part 15 of the cover glass 13. The back light main body 16 is provided at least with light sources (LED, etc., for example) and optical-call members. The optical members have functions such as converting light emitted from the light sources into surface shape.

The main body fixing component 17, as illustrated in FIG. 1, is made of a first main body fixing component 18 which is arranged so as to overlap with the back side (opposite side to the liquid crystal panel 11 side) with respect to the back light main body 16, and is fixed to the back light main body 16, and a second main body fixing component 19 which is attached to the first main body fixing component 18, and arranged so as to surround the back main body 16. The first main body fixing component 18 forms a size larger plate-shape than the cover glass 13, and the center side portion thereof overlaps in a plan view with the back light main body 16 and is fixed to the back light main body 16 by threaded fastener 20. The second main body fixing component 19 forms an oblong frame shape which surrounds the back light main body 16 over the entire periphery, and overlaps in a plan view with the external peripheral side part (non-overlapping portion with the back light main body 16) of the first main body fixing component 18, and at same time, is fixed in an attached state on the external peripheral side part of the first main body fixing component 18 by fixing methods such as a binding mater al and a threaded fastener, etc. The second main body fixing component 19 is made of a body part 19A which is in contact with the first main body fixing component 18 and is opposed to a peripheral end face of the back light main body 16, and a frame part 19B which protrudes toward the front side from the peripheral end in the body part 19A and is opposed to the peripheral end face of the cover glass 13. As for the second main body fixing component 19, although peripheral faces of the body part 19A and the frame part 19B are able to be aligned on the same plane, an inner circumferential surface of the body part 19A is located in more inside than an inner circumferential surface of the frame part 19B, and the body part 19A has become broader than the frame part 19B. As for the second main body fixing component 19, since the inner circumferential surface of the body part 19A is located outside the peripheral face of back light main body 16, it can be said that the second main body fixing component 19 is a protruding overlapped part 21 in which the whole area of the second main body fixing component 19 protrudes outside the peripheral end of the liquid crystal panel 11.

The adherence component 14, as illustrated in FIG. 1 and FIG. 2, has the adhering layer made from adhesive material, etc., applied on each of back-and-front sides of a base material, and is assumed to be a so-called double-sided tape. The adherence component 14 is arranged so as to overlap with the non-display area NAA of the liquid crystal panel 11 in a plan view, and forms an oblong frame shape. The adherence component 14 surrounds the display area AA over the entire periphery, and is assumed to be non-overlapping arrangement with the display area AA in a plan view. As a result, a situation where the light emitted to the display area AA of the liquid crystal panel 11 from the effective light emitting area of the back light device 12 may be interrupted by the adherence component 14 can be prevented from arising, and using of light effectively will be preferably achieved.

The adherence component 14, as illustrated in FIG. 1, intervenes between the liquid crystal panel 11 and the back light device 12 which are overlapped with each other, and each adhering layer of the back and front adheres to the liquid crystal panel 11 and the back light device 12, and thereby, holding of the liquid crystal panel 11 and the back light device 12 is achieved. Meanwhile, since the adherence component 14 is arranged so as not to overlap with the display area AA in the liquid crystal panel 11, it becomes difficult to fully secure an adherence area to the liquid crystal panel 11 and the back light device 12. Moreover, as for the adherence component 14, it may be requested that a soft material may be used as a material of the base material in order to improve cushioning capacity, and when a base material of such a material is used, there is a possibility that fixing force may be deteriorated in comparison with a case where a base material made from a hard material is used. Since the adherence component 14 has restrictions in an arrangement space and a material in this way, it has been difficult to make the fixing force high. On the other hand, since the cover glass 13 is attached to the liquid crystal panel 11 as already mentioned, strong loading due to the weight is applied to the adherence component 14 with respect to the normal line direction of the display surface 11DS when a sudden vibration and shock, etc. are applied, and there is a possibility that a peeling may arise with respect to the adherence component 14. Incidentally, in addition to the above-mentioned sudden vibration and shock, deformation and inclination such as curvature and twisting, etc. may arise in one or both of the cover glass 13/liquid crystal panel 11 and the back light device 12.

Then, a first engaging part 22 is provided in the protruding part 13A constituting the cover glass 13 according to the present embodiment, as illustrated in FIG. 1 and FIG. 3, and on the other hand, the second engaging part 23 which is engageable with the first engaging part 22 in axial direction (normal line direction) with respect to the first engaging part 22 in the protruding overlapped part 21 (second main body fixing component 19) constituting the back light device 12 is provided. Then, the second engaging part 23 is arranged oppositely to the first engaging part 22 with the gap C1 left in the Z axial direction, and in addition, is arranged oppositely to the first engaging part 22 with the gap C2 left in the X axial direction (normal orthogonal direction) which is orthogonal to the Z axial direction. In this way, when sudden vibration and shock are applied on the liquid crystal display device 10 and when the deformation and inclination arise in the cover glass 13, etc., the cover glass 13/liquid crystal panel 11 and the back light device 12 can be prevented from being displaced relatively in the Z axial direction by the first engaging part 22 and the second engaging part 23 being engaged with each other. Thereby, it becomes difficult that the peeling may arise in the adherence component 14. Moreover, in an initial state where the above-mentioned vibration and shock or deformation and inclination, etc. are not applied, the second engaging part 23 is arranged with the gap C1 left in the normal line direction of the display surface 11DS with respect to the first engaging part 22, and thereby, relative displacement between the cover glass 13/liquid crystal panel 11 and the back light device 12 is allowed within the gap C1 in the Z axial direction. As a result, when the above-mentioned vibration and shock or deformation and inclination, etc. are applied, a stress in association with that can be prevented from being applied to the liquid crystal panel 11 without interruption, and deterioration of a displaying quality of the liquid crystal panel 11 is suppressed. In particular, since the liquid crystal panel 11 is assumed to have the IPS mode in the present embodiment, the deterioration of the displaying quality resulting from the stress application tends to arise, and the above descriptions are useful. Furthermore, since the second engaging part 23 is arranged with the gap C2 left in the X axial direction with respect to the first engaging part 22 in the initial state, and is in a state of non-contact with the first engaging part 22, the cover glass 13/liquid crystal panel 11 and the back light device 12 are guaranteed to be displaced relatively smoothly in the Z axial direction, and the strong resistance force as in the past can be prevented from being applied thereon. As a result, since the stress becomes difficult to be applied on the liquid crystal panel 11 in accordance with the relative displacement between the cover glass 13/liquid crystal panel 11 and the back light device 12, the deterioration of the displaying quality of the liquid crystal panel 11 is preferably suppressed.

The first engaging part 22, as illustrated in FIG. 3, is assumed to be a different part from the cover glass 13, and is attached by binding material or the like on the plate surface of the back side in the protruding part 13A. The first engaging part 22 makes a groove-shape viewed from the side, and is opened toward the outside (side opposite to the liquid crystal panel 11 side) in the X axial direction. In detail, the first engaging part 22 is made of a fixing part 22A attached to the plate surface on the back side in the protruding part. 13A of the cover glass 13, a first arm part 22k protruding toward the back side along with the Z axial direction from the fixing part 22A, and a first engaging protruded part 22C protruding along with the X axial direction from a protruding end part of the first arm part 22B so as to be opposed to the fixing part 22A. As for the first engaging part 22, a portion between the fixing part 22A and the first engaging protruded part 22C is made concave, and the portion is made to be an engaging space 22S which is opened outside.

The second engaging part 23, as illustrated in FIG. 3 is formed integrally in the second main body fixing component 19 which is the protruding overlapped part 21. The second engaging part 23 is made of a second arm part 23 A protruding toward the front side along with the Z axial direction from the surface of the front side of a pair of short side parts in the body part 19A constituting the second main body fixing component 19, and a second engaging protruded part 23B protruding toward an inner side (liquid crystal panel 11 side) along with the X axial direction from a protruding end part of the second arm part 23A. The second engaging protruded part 23B makes a nail-shape viewed from the side, and the protruding end part thereof has entered into the engaging space 22S between the fixing part 22A and the first engaging protruded part 22C in the first engaging part 22. Then, the second engaging protruded part 23B having entered in the engaging space 22S, in an initial state, is arranged oppositely to the first engaging protruded part 22C of the first engaging part 22 with the gap C1 left in the Z axial direction. In addition to that, as for the second engaging part 23, the second arm part 23B is arranged oppositely to the first engaging protruded part 22C of the first engaging part 22 with the gap C2 left in the X axial direction. As a result, the cover glass 13 provided with the first engaging part 22 and the liquid crystal panel 11 attached to the cover glass 13 is allowed to be displaced relatively in the Z axial direction to the back light device 12 provided with the second engaging part 23 within the range of the gap C1. At the time of the relative displacement, the second arm part 23B of the second engaging part. 23 is arranged with a gap C2 left to the first engaging protruded part 22C of the first engaging part 22, and thereby, it is avoided that friction arises between the first engaging part 22 and the second engaging part 23, and therefore, a situation where the stress is applied on the liquid crystal panel 11 resulting from the frictional resistance can be avoided. Incidentally, when the cover glass 13 and the liquid crystal panel 11 are displaced relatively to the back light device 12 by the size for the gap C1 the Z axial direction, the second engaging protruded part 23B is engaged with (abutted on) the first engaging protruded part 220, and thereby, the relative displacement greater than that is made to be restricted.

The first engaging part 22, as illustrated in FIG. 1, is arranged so as to be opposed with a gap left to the peripheral end face of the liquid crystal panel 11. The second engaging part 23 is arranged oppositely in the position adjacent to the outside (opposite side to the liquid crystal panel 11 side) with respect to the first engaging part 22 in the X axial direction. Therefore, the first engaging part 22 is arranged so as to intervene between the liquid crystal panel 11 and the second engaging part 23 in the X axial direction. Here, although the second engaging part 23 is provided in the second main body fixing component 19 which is the protruding overlapped part 21 of the back light device 12, and therefore, is able to be displaced relatively to the liquid crystal panel 11, the first engaging part 22 is provided in the cover glass 13, and therefore, is unable to be displaced relatively to the liquid crystal panel 11. Therefore, the first engaging part 22 intervenes between the liquid crystal panel 11 and the second engaging part 23 in the X axial direction, and thereby, it can be prevent that the second engaging part 23 interferes carelessly with the peripheral end of liquid crystal panel 11.

The first engaging part 22, as illustrated in FIG. 1, is provided at least one by one in a pair of short side parts within the protruding part 13A which is the peripheral end of the cover glass 13 and makes an oblong frame shape. On the other hand, the second engaging part 23 is provided at least one by one in a pair of short side parts in the second main body fixing component 19 which is the protruding overlapped part 21 and forms an oblong frame shape In other words, the first engaging part 22 and the second engaging part 23 are each arranged at two positions sandwiching the liquid crystal panel 11 in the X axial direction. Here, when an inclination in the X axial direction arises in the cover glass 13, the one side (left-hand side illustrated in FIG. 4) sandwiching the liquid crystal panel 11 in the X axial direction may become low relatively in the Z axial direction, and the other side (right-hand side illustrated in FIG. 4) may become high relatively in the Z axial direction, as illustrated in FIG. 4, for example. Even in such a case, the first engaging part. 22 arranged at the other side which is higher relatively within the cover glasses 13 is engaged with the second engaging part 23, and thereby, the difference of the position between one side and the other side the Z axial direction can be prevented from spreading endlessly. As a result, the stress becomes difficult to be applied on the liquid crystal panel 11 while the peeling becomes difficult to arise in the adherence component 14.

Meanwhile, the cover glass 13/liquid crystal panel 11 and the back light device 12 may have dimensional changes generated in the Z axial direction in accordance with the deformation and inclination as illustrated in FIG. 4. A value produced by integrating the maximum of the changed dimensions in the cover glass 13/liquid crystal panel 11 and the back light device 12 at this time is assumed to be a maximum integrated value. Then, as for the first engaging part 22 and the second engaging part 23, as illustrated in FIG. 3, the dimension of the gap C1 in the Z axial direction is made larger than the maximum integrated value of the changed dimensions in the Z axial direction in accordance with the deformation which may arise in the cover glass 13/liquid crystal panel 11 and the back light device 12. In this way, even when the cover glass 13/liquid crystal panel 11 and the back light device 12 are deformed to the utmost, the maximum deformation can be absorbed by the gap C1 in the Z axial direction which is provided between the first engaging part 22 and the second engaging part 23. As a result, the stress becomes more difficult to be applied on the liquid crystal panel 11.

As described above, the liquid crystal display device (display device) 10 of the present embodiment includes the liquid crystal panel (display panel) 11 which has the display surface 11DS displaying a picture, the back light device (lighting device) 12 which is arranged so as to overlap with the liquid crystal panel 11 and irradiates the liquid crystal panel 11 with the light for displaying, the adherence component 14 which intervenes between the liquid crystal panel 11 and the backlight device 12 and adheres these, and the cover glass (protective panel) 13 attached to the liquid crystal panel 11 in the form of overlapping with the opposite side to the back light device 12 side. As for the cover glass 13, at least a part of the peripheral end is assumed to be the protruding part 13A protruding outside the outer end of the liquid crystal panel 11, and on the other hand, as for the back light device 12, at least a part of the peripheral end is assumed to be the protruding overlapped part 21 arranged so as to overlap with the protruding part 13A, and there are included the first engaging part 22 provided in the protruding part 13A, and the second engaging part 23 which is provided in the protruding overlapped part 21 and is arranged with gaps C1 and C2 left each in the normal line direction of the display surface 11DS and the normal orthogonal direction which is orthogonal with the normal line direction with respect to the first engaging part 22 and is engageable with the first engaging part 22 at least in the normal line direction.

In this way, a picture is displayed on the display surface 11DS of the liquid crystal panel 11 by using the light emitted from the back light device 12. As for the liquid crystal panel 11, the protection is achieved by the cover glass 13 which is arranged so as to overlap with the opposite side to the back light device 12 side. The cover glass 13 has the protruding part 13A which at least a part of the peripheral end protrudes outside the outer end of the liquid crystal panel 11, and the protruding overlapped part 21 which is made of at least a part of the peripheral end of the back light device 12 is arranged so as to overlap with this protruding part 13A. The liquid crystal panel 11 and the back light device 12 which are overlapped with each other are adhered mutually by the adherence component 14 which intervenes therebetween. Since adhered to the liquid crystal panel 11, the adherence component 14 may have restrictions in an arrangement space and a material, and it may become difficult to make the fixing force high in that case. On the other hand, since the cover glass 13 is attached to the liquid crystal panel 11, strong loading i s applied to the adherence component 14 in the normal line direction of the display surface 11DS when vibration and shock, etc. are applied due to the weight, and there is a possibility that the peeling may arise with respect to the adherence component 14.

Then, the first engaging part 22 is provided in the protruding part 13A of the cover glass 13, and the second engaging part 23 which is enaageable with the first engaging part 22 in the normal line direction of the display surface 11DS is provided in the protruding overlapped part 21 of the back light device 12, and therefore, when the above-mentioned vibration and shock, etc. are applied, the first engaging part 22 and the second engaging part 23 are engaged with each other, and thereby, the cover glass 13/liquid crystal panel 11 and the back light device 12 can be prevented from being displaced relatively in the normal line direction. Thereby, it becomes difficult that the peeling may arise in the adherence component 14. Moreover, the second engaging part. 23 is arranged with a gap C1 left in the normal line direction of the display surface 11DS with respect to the first engaging part 22, and thereby, relative displacement between the cover glass 13/liquid crystal panel 11 and the back light device 12 is allowed within the gap C1 in the above-mentioned normal line direction. As a result, when the above-mentioned vibration and shock or deformation and inclination, etc. are applied, the stress in association with that can be avoided from being applied to the liquid crystal panel 11 without interruption, and deterioration of the displaying quality of the liquid crystal panel 11 is suppressed. Furthermore, the second engaging part 23 is arranged with a gap C2 left in the normal orthogonal direction which is orthogonal with the normal line direction of the display surface 11DS with respect to the first engaging part 22, and thereby, the cover glass 13 and liquid crystal panel 11 and the back light device 12 is guaranteed to be displaced relatively smoothly in the normal line direction, and the strong resistance force as in the past can be prevented from being applied thereon. Thereby, since the stress becomes difficult to be applied on the liquid crystal panel 11 in accordance with the relative displacement between the cover glass 13 and liquid crystal panel 11 and the back light device 12, the deterioration of the displaying quality of the liquid crystal panel 11 is preferably suppressed.

Incidentally, although in addition to the vibration and shock, deformation and inclination, etc. may arise in at least one of the cover glass 13/liquid crystal panel 11 and the back light device 12, even in that case, the stress arising in accordance with the deformation and inclination, etc. becomes difficult to be applied on the liquid crystal panel 11 owing to the first engaging part 22 and second engaging part 23 having the above configuration.

In addition, the first engaging part 22 is arranged so as to intervene between the liquid crystal panel 11 and the second engaging part 23 in the normal orthogonal direction. Since provided in the protruding overlapped part 21 of the back light device 12, the second engaging part 23 is able to be displaced relatively to the liquid crystal panel 11, and however, since provided in the cover glass 13, the first engaging part 22 is unable to be displaced relatively to the liquid crystal panel 11. Therefore, the first engaging part 22 intervenes between the liquid crystal panel 11 and the second engaging part 23 in the normal orthogonal direction, and thereby, it can be prevent that the second engaging part 23 interferes with the peripheral end of the liquid crystal panel 11.

In addition, the first engaging part 22 and the second engaging part 23 are each arranged at two positions sandwiching the liquid crystal panel 11 at least in the normal orthogonal direction. In this way, even when the position difference in the normal line direction arises at one side and the other side which sandwich the liquid crystal panel 11 in the normal orthogonal direction in at least one of the cover glass 13 and the back light device 12, the above mentioned first engaging part 22 and second engaging part 23 which are arranged at one side or the other side are engaged with each other, and thereby, the position difference mentioned above can be prevented from spreading endlessly. As a result, while the peeling becomes difficult to arise in the adherence component 14, the stress becomes difficult to be applied on the liquid crystal panel 11.

In addition, as for the second engaging part 23, the dimensions of the gap C1 in between to the first engaging part 22 in the normal line direction is made larger than the maximum integrated value of the changed dimensions in the normal line direction in accordance with the deformation which may arise in the cover glass 13/liquid crystal panel 11 and the back light device 12. The cover glass 13/liquid crystal panel 11 and the back light device 12 may have dimensional changes generated in the normal line direction in accordance with the deformation and inclination, etc. A value produced by integrating the maximum of the changed dimensions in the cover glass 13/liquid crystal panel 11 and the back light device 12 at this time is assumed to be a maximum integrated value. Then, the dimension of the gap C1 in the normal line direction between the first engaging part 22 and the second engaging part 23 is made larger than the above-mentioned maximum integrated value, and therefore, even when the cover glass 13/liquid crystal panel 11 and the back light device 12 are deformed to the utmost, the maximum deformation can be absorbed by the gap C1 in the normal line direction which is provided between the first engaging part 22 and the second engaging part 23. As a result, the stress becomes more difficult to be applied on the liquid crystal panel 11.

In addition, the back light device 12 is made of the back light main body (lighting device main body) 16 which emits light and the main body fixing component 17 fixed to the back light main body 16, and the second engaging part 23 is provided in the main body fixing component 17. In this way, in comparison with temporarily a case where the second engaging part 23 is provided in the back light main body 16, for example, installation flexibility of the second engaging part 23 becomes high while it becomes easy to secure an installing space of the second engaging part 23.

In addition, in the main body fixing component 17, at least included are the first main body fixing component 18 which is arranged so as to overlap with the opposite side to the liquid crystal panel 11 side with respect to the back light main body 16, and is fixed to the back light main body 16, and the second main body fixing component 19 which is attached to the first main body fixing component 18 and is arranged so as to surround the back light main body 16, and of which the whole area becomes the protruding overlapped part 21, and the second engaging part 23 is provided in the second main body fixing component 19. The second main body fixing component 19 is attached to the first main body fixing component 18 fixed to the back light main body 16, and is arranged so as to surround the back light main body 16, and the whole area thereof is the protruding overlapped part 21. Since the second engaging part 23 is provided in the second main body fixing component 19, it becomes easier to secure the installing space of the second engaging part 23, and at same time, the installation flexibility of the second engaging part 23 becomes higher.

In addition, the liquid crystal panel 11 has the display surface 11DS divided into the display area AA where a picture is displayed and the non-display area NAA surrounding the display area AA, and the adherence component 14 is arranged in the non-display area NAA and forms a picture frame-like shape. In this way, since the adherence component 14 is made to be arranged so as to be non-overlapped with the display area AA, problems such that the light with which the display area AA in the display surface 11DS of the liquid crystal panel 11 is irradiated from the back light device 12 is interrupted by the adherence component 14 become difficult to arise, which become suitable when keeping the displaying quality high. Although it may become difficult to fully secure the fixing force to adhere the liquid crystal panel 11 and the back light device 12 when arranging of the adherence component 14 has the above restrictions, the peeling becomes difficult to arise in the adherence component 14 by the first engaging part 22 and the second engaging part 23 being engaged with each other.

### Second Embodiment

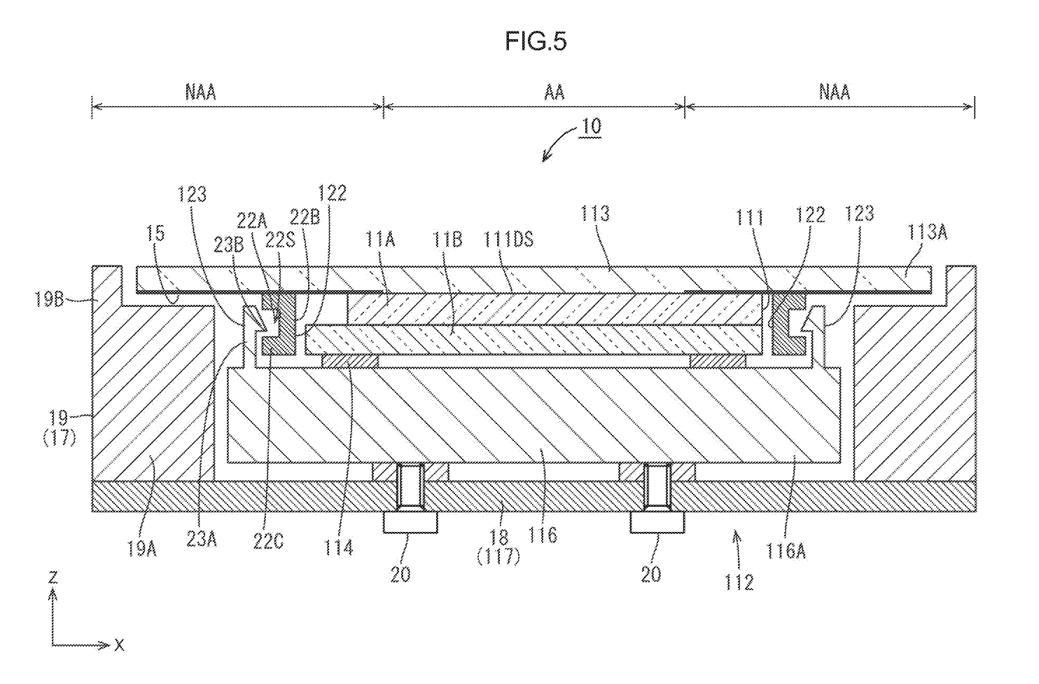

A second embodiment will be described with reference to FIG. 5. In the second embodiment, described is one where an object to which a second engaging part 123 is installed is changed. Note that with respect to the same configuration, operation and effect as the above-mentioned first embodiment, overlapping descriptions are omitted.

The second engaging part 123 according to the present embodiment, as illustrated in FIG. 5, is provided not in a main body fixing component 117 but in a back light main body 116 within a back light device 112. In detail, the second engaging part 123 is provided in a main body protruding overlapped part 116A which is protruded outside the outer end of a liquid crystal panel 111 and overlaps with a protruding part 113A of a cover glass 113 in a plan view within the back light main bodies 116. The second engaging part 123 is provided in a form of protruding toward the front side from the surface on the front side in the main body protruding overlapped part 116A. A first engaging part 122 engaged with the second engaging part 123 is arranged at a position which is opposite to the main body protruding overlapped part 116A within the protruding part 113A of the cover glass 113. In this way, since the second engaging part 123 is provided in the back light main body 116 which is an displacement restricted object by the first engaging part 122 and the second engaging part 123, the relative displacement in the Z axial direction which may arise in the liquid crystal panel 111 and the back light, device 112 can be restricted directly. As a result, the peeling becomes much more difficult to arise in the adherence component 114 adhering the liquid crystal panel 111 and the back light device 112 mutually.

According to the present embodiment as described above, the back light device 112 is made of the back light main body 116 which emits light and the main body fixing component 117 fixed to the back light main body 116, and the second engaging part 123 is provided in the back light main body 116. In this way, the liquid crystal panel 111 and the back light device 112 are able to be prevented directly from being displaced relatively in the normal line direction of the display surface 111DS by the second engaging part 123 provided in the back light main body 116. As a result, the peeling becomes much more difficult to arise in the adherence component 114.

### Third Embodiment

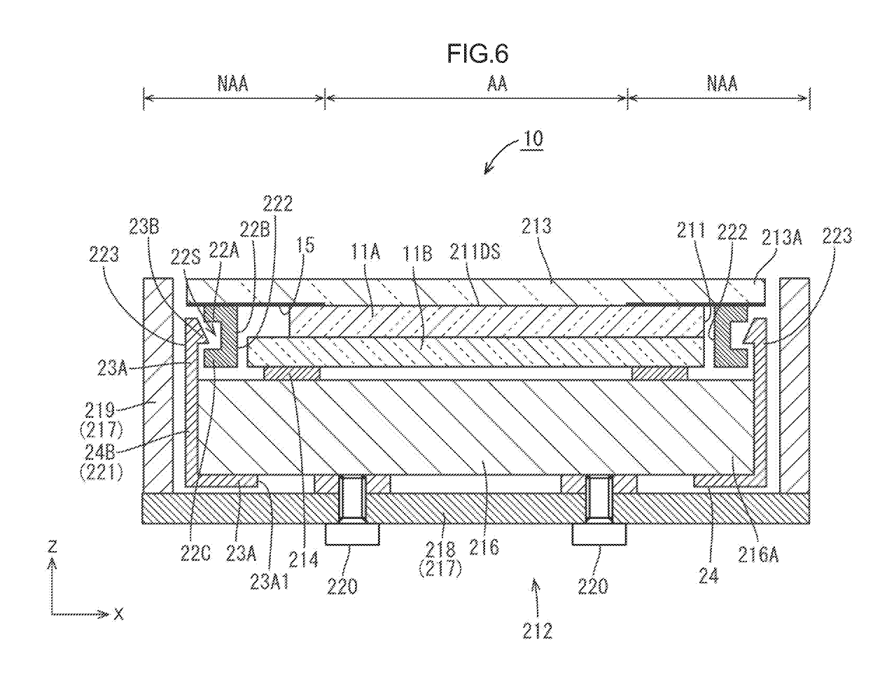

A third embodiment will be described with reference to FIG. 6. In the third embodiment, described is one where an object to which a second engaging part 223 is installed is changed from the above-mentioned first embodiment. Note that with respect to the same configuration, operation and effect as the above-mentioned first embodiment, overlapping descriptions are omitted.

In a main body fixing component 217 according to the present embodiment, as illustrated in FIG. 6, a case 24 where a back light main body 216 is stored is included in addition to a first main body fixing component 218 and a second main body fixing component 219. The case 24 forms a approximate box-shape which has an accommodation space for the back light main body 216 in the inside thereof, and is made of a bottom part 24A which overlaps with the back side of the back light main body 216, and a side part 24B which protrudes toward the front side from the peripheral end of the bottom part 24A and is opposite to the peripheral end face in the back light main body 216. In the bottom part 24A of the case 24, formed is an opening 24A1 through which passed is a threaded fastener 220, etc. for fixing the first main body fixing component 218 to the back light main body 216. The side part 24B of the case 24 has become a protruding overlapped part 221 which protrudes outside the outer end of a liquid crystal panel 211, and overlaps with a protruding part 213A of a cover glass 213 in a plan view. Then, a second engaging part 223 is provided integrally in the side part 24B which is the protruding overlapped part 221 within the cases 24. In detail, the second engaging part 223 is provided in a form of further protruding along with the Z axial direction toward the front side from a rising-up tip part from the bottom part 24A in side part 24B. A first engaging part 222 engaged with the second engaging part 223 is arranged at the position which is opposite to a main body protruding overlapped part 216A of the back light main body 216 within the protruding part 213A of the cover glass 213. Thus, the second engaging part 223 is provided in the case 24 to store the back light main body 216 which is an displacement restricted object, by the first engaging part 222 and the second engaging part 223, and thereby, the relative displacement in the Z axial direction which may arise in the liquid crystal panel 211 and the back 1 device 212 is preferably restricted. As a result, the peeling becomes more difficult to arise in the adherence component 114 which is adhered to the liquid crystal panel 211 and the back light device 212.

According to the present embodiment as described above, in the main body fixing component 217, included is at least the case 24 which stores the back light main body 216 and a part of which becomes the protruding overlapped part 221, and the second engaging part 223 is provided in the case 24. In this way, the liquid crystal panel 211 and the back light device 212 are prevented from being displaced relatively in the normal line direction of the display surface 211DS by the second engaging part 223 which is provided in the case 24 storing the back light main body 216. As a result, the peeling becomes more difficult to arise in the adherence component 214.

### Other Embodiments

The technology described herein is not limited to the embodiments described by the above-mentioned descriptions and drawings, and the following embodiments are also included in the technical scope of the technology described herein, for example.

(1) In addition to the protection function, the cover glass may have a touch-panel function (position detecting function). In that case, a touch-panel pattern for detecting an input position when a user inputs position information in accordance with a picture displayed on a display area of the liquid crystal panel will be provided on the cover glass. The touch-panel pattern is formed by patterning a transparent electrode film and a mesh-shaped metal film, etc. on a portion overlapped with the display area of the liquid crystal panel in the cover glass.

(2) The first engaging part and the second engaging part are also able to be provided each in a pair of long side parts in the protruding part and the protruding overlapped part. In addition, the first engaging part and the second engaging part may be provided in a pair of short side parts and in a pair of long side parts in the protruding part and the protruding overlapped part, respectively.

(3) The first engaging part and the second engaging part may be provided in one short side part or long side part in the protruding part and in the protruding overlapped part.

(4) Although detailed illustrations with respect to arrangement according to the first engaging part and the second engaging part in the short side direction in each short side part of the protruding part and the protruding overlapped part is omitted, as for the first engaging part and the second engaging part, only one pair may be provided in the short side direction (long side direction) in each short side part (each long side) of the protruding part and the protruding overlapped part, and one or more pairs may be provided with a gap left, for example

(5) It is also possible to adopt an arrangement where the second engaging part intervenes between the liquid crystal panel and the first engaging part.

(6) The specific dimension design of each gap between the first engaging part and the second engaging part can be changed suitably. In addition to that, the specific arrangement or the like in the X axial direction (Y axial direction) in the first engaging part and the second engaging part can be suitably changed.

(7) It is also possible to make the second engaging part groove-shaped and to make the first engaging protruded part of the first engaging part nail-shaped. In addition to that, it is possible to change suitably the specific engagement structure of the first engaging part and the second engaging part.

(8) A configuration where only a part in the peripheral direction in the peripheral end of the cover glass is assumed to be the protruding part which protrudes outside from the outer end of the liquid crystal panel may be acceptable.

(9) A configuration where only a part in the peripheral direction in the peripheral end of the back light device is assumed to the protruding overlapped part which protrudes outside from the outer end of the liquid crystal panel and overlaps with the protruding part may be acceptable.

(10) A configuration where the peripheral end of the back light main body does not protrude outside from the peripheral end of the liquid crystal panel may be acceptable.

(11) It is also possible to constitute the back light device only from the back light main body provided with the second engaging part and to omit the main body fixing component.

(12) It is also possible to use together the first engaging part and the second engaging part which are described in the first embodiment to the configuration described in the above-mentioned second embodiment.

(13) With the configuration described in the above-mentioned third embodiment, it is also possible to use together the first engaging part and the second engaging part which are described in the first embodiment, and the first engaging part and the second engaging part which are described in the second embodiment.

(14) A configuration where the frame part of the second main body fixing component is arranged so as to be opposite to the plate surface on the back side in the cover glass may be acceptable.

(15) It is also possible to use for example an OCA film and OCR (Optical Clear Resin) as an adherence component, or to use a binding material.

(16) In addition to each above-mentioned embodiment, specific materials such as a glass material in the CF substrate and array substrate which constitute the liquid crystal panel, and a glass material in the cover glass can be changed suitably. In this case, it is also possible to use a material other than glass (synthetic resin material etc.) as a material of the CF substrate, the array substrate and the cover glass (protective panel).

(17) As the display mode of the liquid crystal panel, an FFS mode, a TN mode, a VA mode or an RTN mode, etc. may be acceptable.

(18) The plane shape of the liquid crystal display device may be acceptable which is a longwise rectangle, a square, an ellipse, an elliptical form, a circular, a trapezoid or a shape having a curved surface partially, etc.

(19) In addition to the transmissive liquid crystal display device, a semi-transmissive liquid crystal display may be acceptable.

(20) A display device using another kind of display panel may be acceptable.

1. A display device comprising:
a display panel configured to have a display surface to display an image;
a lighting device configured to be arranged so as to overlap with the display panel and to irradiate the display panel with light for displaying;
an adherence component that is between the display panel and the lighting device and connects the display panel and the lighting device; and
a protective panel configured to be attached on the display panel on an opposite side from the lighting device while overlapping the display panel, wherein
the protective panel has a part of a peripheral end as a protruding part protruding outside an outer end of the display panel,
the lighting device has a part of a peripheral end as a protruding overlapped part arranged so as to overlap with the protruding part,
the protruding part includes a first engaging part,
the protruding overlapped part includes a second engaging part, and
the first engaging part is spaced from the second engaging part while having a space therebetween with respect to a normal line direction of the display surface and a normal orthogonal direction orthogonal to the normal line direction and the second engaging part is configured to be fit to the first engaging part at least in the normal line the direction.

2. The display device according to claim 1, wherein the first engaging part s arranged between the display panel and the second engaging part in the normal orthogonal direction.

3. The display device according to claim 1, wherein the first engaging part and the second engaging part are each arranged at two positions sandwiching the display panel at least in the normal orthogonal direction.

4. The display device according to claim 1, wherein the space between the first engaging part and the second engaging part in the normal line direction is larger than a maximum integrated value of a changed dimension of the second engaging part in the normal line direction according to deformation that may arise in the protective panel, the display panel and the lighting device.

5. The display device according to claim 1, wherein the lighting device includes a lighting device main body emitting light and a main body fixing component fixed to the lighting device main body, and
the second engaging part is provided in the main body fixing component.

6. The display device according to claim 5, wherein
the main body fixing component includes at least a first main body fixing component that is arranged so as to overlap with the lighting device main body on an opposite side to the display panel side and fixed to the lighting device main body, and a second main body fixing component that is attached to the first main body fixing component and is arranged so as to surround the lighting device main body, and the second main body fixing component corresponds to the protruding overlapped part as a whole, and
the second engaging part is provided in the second main body fixing component.

7. The display device according to claim 5, wherein
the main body fixing component includes at least a casing in which the lighting device main body is arranged and a part of which corresponds to the protruding overlapped part, and
the second engaging part is provided in the casing.

8. The display device according to claim 1, wherein
the lighting device includes a lighting device main body emitting light and a main body fixing component fixed to the lighting device main body, and
the second engaging part is provided in the lighting device main body.

9. The display device according to claim 1, wherein
the display panel has the display surface divided into a display area in which the image is displayed and a non-display area that surrounds the display area, and
the adherence component is arranged in the non-display area and formed in a frame shape.
